(19) United States
(12) Patent Application Publication
(10) Pub. No.: US 2024/0239971 A1
(43) Pub. Date: Jul. 18, 2024

(54) COMPOSITIONS BASED ON POLYAMIDES AND GLASS FIBERS AND USE THEREOF IN THE FIELDS OF SANITATION AND WATER MANAGEMENT

(71) Applicant: ARKEMA FRANCE, COLOMBES (FR)

(72) Inventors: Mathieu SABARD, Serquigny (FR); Fabrice GLASSON, Serquigny (FR); Clio COCQUET, Colombes Cedex (FR); Patrick Dang, Serquigny (FR)

(73) Assignee: ARKEMA FRANCE, COLOMBES (FR)

(21) Appl. No.: 18/558,852

(22) PCT Filed: Apr. 29, 2022
(86) PCT No.: PCT/FR2022/050827

§ 371 Date: Nov. 3, 2023

(30) Foreign Application Priority Data
May 5, 2021 (FR) FR2104728

(51) Int. Cl. C08J 5/04; B29B 7/00; B29B 7/48; B29K 77/00; B29K 105/12; B29K 309/08; B29K 509/08

(52) U.S. Cl. CPC C08J 5/043; B29B 7/007; B29B 7/48; B29K 2077/00; B29K 2105/12; B29K 2309/08; B29K 2509/08; C08J 2377/04

(57) ABSTRACT

The present invention relates to a molding composition comprising, by weight:
a) 20% to 60% of at least one long-chain aliphatic polyamide having a number of carbon atoms per nitrogen atom of greater than or equal to 9,
said at least one polyamide having an inherent viscosity in solution of less than or equal to 1.3, as determined in accordance with the standard ISO 307:2007 at a temperature of 20° C.,
b) 40% to 75% of glass fibers, and
c) 0% to 5% by weight, by weight of at least one additive,
the sum of the proportions of each constituent of said composition being equal to 100%,
with the exclusion of an amorphous polyamide and a microcrystalline polyamide.

### TECHNICAL FIELD

The present invention relates to molding compositions based on polyamides and glass fibers and the use thereof in the field of sanitation, transport or distribution of water, in particular of drinking water, at a temperature of less than or equal to 60° C.

### PRIOR ART

Brass is a material widely used in the field of sanitation, but this material is expensive. The use thereof may also involve the release of heavy metals into the water and in particular the drinking water. For these reasons, brass is replaced with plastic materials (of the PPSU, PVDF, PA type).

For instance, patent application US 2010/0249307 describes polyamide compositions reinforced with glass fibers for use in the field of drinking water, said polyamide being a mixture of semicrystalline aliphatic polyamide and amorphous transparent polyamide, in particular on diamines based cycloaliphatic such as 3,3′-dimethyl-4,4′-diaminodicyclohexylmethane (referred to as BMACM, MACM or B), p-bis(aminocyclohexyl)methane commonly (referred to as PACM or P) and isophoronediamine (referred to as IPD).

Patent application US2010237271 describes polyamide compositions reinforced with glass fibers for use in the field of drinking water, said polyamide being a mixture of semicrystalline aliphatic polyamide and amorphous transparent polyamide chosen from B9-36, B9-36/P9-36, 12/BI and 12/BT.

International patent application WO 2018/011291 describes compositions comprising a polyamide and a condensation product of a phenol and a carbonyl compound.

None of these patent applications describes molding compositions based on long-chain aliphatic polyamides and glass fibers having improved mechanical properties at temperatures of less than or equal to 60° C., in particular in terms of creep strength or stresses at break, before or after immersion in drinking water.

Thus, the present invention relates to a molding composition comprising, by weight:
a) 20% to 60%, especially from 20% to 50%, in particular 25% to 39.9%, of at least one long-chain aliphatic polyamide having a number of carbon atoms per nitrogen atom of greater than or equal to 9, in particular greater than or equal to 10,
said at least one polyamide having an inherent viscosity in solution of less than or equal to 1.3, in particular less than or equal to 1.25, as determined in accordance with the standard ISO 307:2007 at a temperature of 20° C.,
b) 40% to 75% of glass fibers, especially from 50% to 75%, in particular from 60% to 70%, of glass fibers, and
c) 0% to 5% by weight, preferably 0.1% to 5% by weight, of at least one additive,
the sum of the proportions of each constituent of said composition being equal to 100%.

The inventors have thus found that the selection of at least one long-chain aliphatic polyamide having a particular inherent viscosity in solution with a particular range of glass fibers made it possible to constitute a composition which, after injection molding, exhibits improved mechanical properties at temperatures of less than or equal to 60° C., in particular in terms of creep strength or stresses at break before or after immersion in drinking water.

The inherent viscosity in solution (iv) is determined in accordance with the standard ISO 307:2007 modified in that the solvent is m-cresol rather than sulfuric acid, in that the concentration is 0.5% by weight and in that the temperature is 20° C.

A molding composition according to the invention is a composition transformed, for example, by injection molding, injection blow molding, expansion molding and rotational molding.

### Regarding the Aliphatic Polyamide

The molding composition comprises from 20% to 60%, especially from 20% to 50%, in particular 25% to 39.9%, of at least one long-chain aliphatic polyamide having a number of carbon atoms per nitrogen atom of greater than or equal to 9, in particular greater than or equal to 10.

The nomenclature used to define the polyamides is described in the standard ISO 1874-1:2011, “Plastics—Polyamide (PA) Moulding and Extrusion Materials—Part 1: Designation”, in particular on page 3 (tables 1 and 2), and is well known to a person skilled in the art.

The polyamide can be a homopolyamide or a copolyamide or a mixture thereof.

Said polyamide is advantageously a semicrystalline polyamide or copolyamide.

For the purposes of the invention, the term “semicrystalline” denotes a (co)polyamide which has a melting point (Tm) in DSC according to the standard ISO 11357-3:2013, and an enthalpy of crystallization during the cooling step at a rate of 20 K/min in DSC measured in accordance with the standard ISO 11357-3 of 2013 which is greater than 20 J/g, preferably greater than 30 J/g.

Said polyamide is derived from a repeating unit obtained by polycondensation:
of at least one C₉ to C₁₈, preferentially C₁₀ to C₁₈, more preferentially C₁₀ to C₁₂, amino acid, or
of at least one C to C₁₈, preferentially C₁₀ to C₁₈, more preferentially C₁₀ to C₁₂, lactam, or
of at least one C₄-C₃₆, preferentially C₆-C₁₈, preferentially C₆-C₁₂, more preferentially C₁₀-C₁₂, diamine Ca with at least one C₄-C₃₆, preferentially C₆-C₁₈, preferentially C₆-C₁₂, more preferentially C₁₀-C₁₂, dicarboxylic acid Cb,
or a mixture thereof,
provided that the number of carbon atoms per nitrogen atom in the repeating unit is greater than or equal to 9, in particular greater than or equal to 10.

Advantageously, the long-chain aliphatic polyamide is obtained by polycondensation:
of at least one C₉ to C₁₈, preferentially C₁₀ to C₁₈, especially C₁₀ to C₁₂, amino acid, or
of at least one C₉ to C₁₈, preferentially C₁₀ to C₁₈, especially C₁₀ to C₁₂, lactam.

A C₉ to C₁₈ amino acid is in particular 9-aminononanoic acid, 10-aminodecanoic acid, 10-aminoundecanoic acid, 12-aminododecanoic acid and 11-aminoundecanoic acid and also derivatives thereof, in particular N-heptyl-11-aminoundecanoic acid.

A C₉ to C₁₈ lactam is in particular lauryllactam.

Said at least one C₄-C₃₆ diamine Ca may be chosen in particular from 1,4-butanediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and diamines obtained from fatty acids.

Advantageously, said at least one diamine Ca is C₆-C₁₈ and is chosen from 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine.

Said at least one C₄-C₃₆ dicarboxylic acid Cb may be chosen from succinic acid, glutaric acid, adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, octadecenediamine, eicosanediamine, docosanediamine and diamines obtained from fatty acids.

Advantageously, said at least one dicarboxylic acid Cb is C₆-C₁₈ and is chosen from adipic acid, suberic acid, azelaic acid, sebacic acid, undecanedioic acid, dodecanedioic acid, brassylic acid, tetradecanedioic acid, pentadecanedioic acid, hexadecanedioic acid and octadecanedioic acid.

In particular, the long-chain aliphatic polyamide is chosen from:
polyamide 1010 (PA1010), polyamide 1012 (PA1012), polyamide 1212 (PA1012), polyamide 11 (PA11), polyamide 12 (PA12), or a mixture thereof or a copolyamide thereof.

Advantageously, the polyamide is in particular PA11 and PA12.

In one embodiment, said long-chain aliphatic polyamide is a mixture of two polyamides in a weight ratio range from 5/95 to 95/5.

Advantageously, said mixture is a mixture of two identical polyamides having the same number of carbon atoms per nitrogen atom but with an inherent viscosity in solution of one of the two polyamides of greater than 1.3, but on the condition that the mixture satisfies the condition of having an inherent viscosity in solution of less than or equal to 1.3, in particular less than or equal to 1.25.

### Regarding the Glass Fibers

The glass fibers are present at from 40% to 75%, especially from 50% to 75%, in particular from 60% to 70%, by weight relative to the total weight of the composition.

The glass fibers may be solid and/or hollow; advantageously they are solid.

The glass fibers are advantageously short.

The short glass fibers preferably have a length of between 2 and 13 mm and preferably from 3 to 8 mm before use of the compositions.

Advantageously, the short glass fibers have a fiber length of from 120 to 350 μm.

This fiber length of from 120 to 350 μm is measured on the compound.

The short glass fibers may be of circular or non-circular cross section.

A fiber of circular cross section is defined as a fiber having at any point on its circumference an equal distance to the center of the fiber and therefore represents a perfect or near-perfect circle.

Any glass fiber that does not have this perfect or near-perfect circle is therefore defined as a fiber of non-circular cross section.

Examples of fibers of non-circular cross section, without being limited thereto, are non-circular fibers, having for example an elliptical, oval or cocoon shape, star-shaped fibers, flake-shaped fibers, flat fibers, cruciforms, a polygon and a ring.

The glass fiber may be:
either of circular cross section with a diameter of from 4 μm to 25 μm, preferably from 4 to 15 μm;
or of non-circular cross section with an L/D ratio (L representing the largest dimension of the cross section of the fiber and D the smallest dimension of the cross section of said fiber) of from 2 to 8, in particular from 2 to 4. L and D can be measured by scanning electron microscopy (SEM).

Advantageously, the glass fibers are circular.

### Regarding the Additive

The at least one additive is optionally present at from 0% to 5% by weight, in particular from 0.1% to 5%, relative to the total weight of the composition.

The additive is chosen from fillers, dyes, stabilizers, plasticizers, surface-active agents, nucleating agents, pigments, brighteners, antioxidants, lubricants, flame retardants, natural waxes, additives for laser marking, and mixtures thereof.

By way of example, the stabilizer may be a UV stabilizer, an organic stabilizer or more generally a combination of organic stabilizers, such as an antioxidant of phenol type (for example of the type of that of Irganox® 1010 from Ciba-BASF).

It would not be a departure from the scope of the invention to use a mixture of plasticizers.

By way of example, the fillers may be chosen from carbon black, talc, pigments and metal oxides (titanium oxide).

### Regarding the Molding Composition

Throughout the description, all the percentages of the composition are given by weight.

The molding composition comprises, by weight:
a) 20% to 60%, especially from 20% to 50%, in particular 25% to 39.9%, of at least one long-chain aliphatic polyamide having a number of carbon atoms per nitrogen atom of greater than or equal to 9, in particular greater than or equal to 10, said at least one polyamide having an inherent viscosity in solution of less than or equal to 1.3, in particular less than or equal to 1.25, as determined in accordance with the standard ISO 307:2007 at a temperature of 20° C.,
b) 40% to 75% of glass fibers, especially from 50% to 75%, in particular from 60% to 70%, of glass fibers, and
c) 0% to 5% by weight, preferably 0.1% to 5% by weight, of at least one additive, the sum of the proportions of each constituent of said composition being equal to 100%, with the exclusion of an amorphous polyamide and a microcrystalline polyamide.

For the purposes of the invention, an amorphous polyamide denotes an amorphous transparent polyamide having only one glass transition temperature (no melting point (Tm)), or a polyamide with very low crystallinity, having a glass transition temperature and a melting point such that the enthalpy of crystallization during the cooling step at a rate of 20K/min in Differential Scanning calorimetry (DSC) measured in accordance with the standard ISO 11357-3:2013 is less than 20 J/g. The glass transition temperature (Tg) measured by DSC at a heating rate of 20 K/min in accordance with the standard ISO 11357-2:2013 for these polyamides is greater than 75° C.

For the purposes of the invention, a microcrystalline polyamide has an enthalpy of crystallization during the cooling step at a rate of 20 K/min in Differential Scanning calorimetry (DSC) measured in accordance with the standard ISO 11357-3:2013 which is less than 20 J/g.

A microcrystalline polyamide is therefore excluded from said molding composition.

An amorphous polyamide is, for example, a polyamide based on at least one cycloaliphatic diamine such as MACM, PACM and IPD.

An amorphous polyamide is therefore excluded from said molding composition.

A microcrystalline polyamide and an amorphous polyamide in the form of a mixture are therefore excluded from said molding composition.

Advantageously, a polyamide other than an aliphatic, in particular semicrystalline, polyamide, is excluded from the composition.

Advantageously, a condensation product of a phenol and a carbonyl compound is excluded from the composition.

Advantageously, a polyamide other than an aliphatic, in particular semicrystalline, polyamide and a condensation product of a phenol and a carbonyl compound are excluded from the composition.

In one embodiment, the molding composition consists of (by weight):
a) 20% to 60%, especially from 20% to 50%, in particular 25% to 39.9%, of at least one long-chain aliphatic polyamide having a number of carbon atoms per nitrogen atom of greater than or equal to 9, in particular greater than or equal to 10,
said at least one polyamide having an inherent viscosity in solution of less than or equal to 1.3, in particular less than or equal to 1.25, as determined in accordance with the standard ISO 307:2007 at a temperature of 20° C.,
b) 40% to 75% of glass fibers, especially from 50% to 75%, in particular from 60% to 70%, of glass fibers, and
c) 0% to 5% by weight, preferably 0.1% to 5% by weight, of at least one additive, the sum of the proportions of each constituent of said composition being equal to 100%.

It is quite obvious that when the composition “consists of”, the exclusions are no longer necessary since the composition can only contain the constituents a), b) and c).

In a first variant, the molding composition comprises, by weight:
a) 20% to 50%, in particular 25% to 39.9%, of at least one long-chain aliphatic polyamide having a number of carbon atoms per nitrogen atom of greater than or equal to 9, in particular greater than or equal to 10,
said at least one polyamide having an inherent viscosity in solution of less than or equal to 1.3, in particular less than or equal to 1.25, as determined in accordance with the standard ISO 307:2007 at a temperature of 20° ° C.,
b) 50% to 75%, in particular from 60% to 70%, of glass fibers, and
c) 0% to 5% by weight, preferably 0.1% to 5% by weight, of at least one additive,
the sum of the proportions of each constituent of said composition being equal to 100%,
with the exclusion of an amorphous polyamide and a microcrystalline polyamide.

In one embodiment of this first variant, the molding composition comprises, by weight:
a) 20% to 49.9%, in particular 25% to 39.9%, of at least one long-chain aliphatic polyamide having a number of carbon atoms per nitrogen atom of greater than or equal to 9, in particular greater than or equal to 10,
said at least one polyamide having an inherent viscosity in solution of less than or equal to 1.3, in particular less than or equal to 1.25, as determined in accordance with the standard ISO 307:2007 at a temperature of 20° C.,
b) 50% to 75%, in particular from 60% to 70%, of glass fibers, and
c) 0.1% to 5% by weight of at least one additive,
the sum of the proportions of each constituent of said composition being equal to 100%,
with the exclusion of an amorphous polyamide and a microcrystalline polyamide.

In another embodiment of this first variant, the composition consists of:
a) 20% to 50%, in particular 25% to 39.9%, of at least one long-chain aliphatic polyamide having a number of carbon atoms per nitrogen atom of greater than or equal to 9, in particular greater than or equal to 10,
said at least one polyamide having an inherent viscosity in solution of less than or equal to 1.3, in particular less than or equal to 1.25, as determined in accordance with the standard ISO 307:2007 at a temperature of 20° ° C.,
b) 50% to 75%, in particular from 60% to 70%, of glass fibers, and
c) 0% to 5% by weight, preferably 0.1% to 5% by weight, of at least one additive,
the sum of the proportions of each constituent of said composition being equal to 100%.

In yet another embodiment of this first variant, the composition consists of:
a) 20% to 49.9%, in particular 25% to 39.9%, of at least one long-chain aliphatic polyamide having a number of carbon atoms per nitrogen atom of greater than or equal to 9, in particular greater than or equal to 10,
said at least one polyamide having an inherent viscosity in solution of less than or equal to 1.3, in particular less than or equal to 1.25, as determined in accordance with the standard ISO 307:2007 at a temperature of 20° C.,
b) 50% to 75%, in particular from 60% to 70%, of glass fibers, and
c) 0.1% to 5% by weight of at least one additive,
the sum of the proportions of each constituent of said composition being equal to 100%.

In a second variant, the molding composition comprises, by weight:
a) 25% to 40%, in particular 25% to 39.9%, of at least one long-chain aliphatic polyamide having a number of carbon atoms per nitrogen atom of greater than or equal to 9, in particular greater than or equal to 10, said at least one polyamide having an inherent viscosity in solution of less than or equal to 1.3, in particular less than or equal to 1.25, as determined in accordance with the standard ISO 307:2007 at a temperature of 20° C.,
b) 60% to 70% of glass fibers, and
c) 0% to 5% by weight, preferably 0.1% to 5% by weight, of at least one additive,
the sum of the proportions of each constituent of said composition being equal to 100%,
with the exclusion of an amorphous polyamide and a microcrystalline polyamide.

In one embodiment of this second variant, the molding composition comprises, by weight:
a) 25% to 39.9% of at least one long-chain aliphatic polyamide having a number of carbon atoms per nitrogen atom of greater than or equal to 9, in particular greater than or equal to 10,
said at least one polyamide having an inherent viscosity in solution of less than or equal to 1.3, in particular less than or equal to 1.25, as determined in accordance with the standard ISO 307:2007 at a temperature of 20° C.,
b) 60% to 70% of glass fibers, and
c) 0.1% to 5% by weight of at least one additive,
the sum of the proportions of each constituent of said composition being equal to 100%,
with the exclusion of an amorphous polyamide and a microcrystalline polyamide.

In another embodiment of this second variant, the molding composition consists of:
a) 25% to 40%, in particular 25% to 39.9%, of at least one long-chain aliphatic polyamide having a number of carbon atoms per nitrogen atom of greater than or equal to 9, in particular greater than or equal to 10, said at least one polyamide having an inherent viscosity in solution of less than or equal to 1.3, in particular less than or equal to 1.25, as determined in accordance with the standard ISO 307:2007 at a temperature of 20° C.,
b) 60% to 70% of glass fibers, and
c) 0% to 5% by weight, preferably 0.1% to 5% by weight, of at least one additive,
the sum of the proportions of each constituent of said composition being equal to 100%.

In yet another embodiment of this second variant, the molding composition consists of:
a) 25% to 39.9% of at least one long-chain aliphatic polyamide having a number of carbon atoms per nitrogen atom of greater than or equal to 9, in particular greater than or equal to 10,
said at least one polyamide having an inherent viscosity in solution of less than or equal to 1.3, in particular less than or equal to 1.25, as determined in accordance with the standard ISO 307:2007 at a temperature of 20° C.,
b) 60% to 70% of glass fibers, and
c) 0.1% to 5% by weight of at least one additive,
the sum of the proportions of each constituent of said composition being equal to 100%.

According to another aspect, the present invention relates to the use of a composition as defined above for the manufacture of an article for the field of sanitation, transport or distribution of water, in particular of drinking water, at a temperature of less than 60° C.

All of the embodiments described above are valid for this “use” paragraph.

The expression “article for the field of sanitation, transport or distribution of water” denotes, for example, all the articles used in rooms with water, in particular the bathroom, kitchen, laundry room, toilets, etc. This article denotes a valving element, a piping element, a supply element, a discharge element and a connection element. This article may be a container, a conduit, a fitting, a connector, a quick connector, a screw, a flow-control device, an element of a flow-control device, a valve, a filter element and a structural part.

The transport or distribution of water in the present invention relates to water, whether this be drinking water or otherwise, at a temperature of less than or equal to 60° C.

In one embodiment, the article is chosen from a container, a conduit, a fitting, a connector, a quick connector, a screw, a flow-control device, an element of a flow-control device, a valve and a filter element and a structural part.

Advantageously, the article has improved mechanical properties compared to an article the inherent viscosity in solution of which is greater than 1.3, determined at 23° C. in accordance with the standard ISO 527:2012 on a type 1A test specimen.

Advantageously, the article has improved mechanical properties compared to an article the inherent viscosity in solution of which is greater than 1.3, determined at 60° C. in accordance with the standard ISO 527:2012 on a type 1A test specimen.

Advantageously, the article has an improved creep strength compared to an article the inherent viscosity in solution of which is greater than 1.3, as determined in accordance with ISO 899-1:2017 on a type 1A test specimen.

More advantageously, the article has improved mechanical properties compared to an article the inherent viscosity in solution of which is greater than 1.3, determined at 23° C. and at 60° ° C., in accordance with the standard ISO 527:2012 on a type 1A test specimen.

Even more advantageously, the article has improved mechanical properties compared to an article the inherent viscosity in solution of which is greater than 1.3, determined at 23° C. and at 60° C., in accordance with the standard ISO 527:2012 on a type 1A test specimen, and an improved creep strength compared to an article the inherent viscosity in solution of which is greater than 1.3, as determined in accordance with ISO 899-1:2017 on a type 1A test specimen.

Advantageously, the article is manufactured by injection molding.

According to yet another aspect, the present invention relates to an article obtained by injection molding with a composition as defined above.

### EXAMPLES

Preparation of the compositions of the invention and mechanical properties:

The compositions of table 1 were prepared by melt mixing polyamide pellets with glass fibers and optionally additives.

The PA11- and PA12-based compositions were processed by compounding on a co-rotating twin-screw extruder with a diameter of 40 mm with a flat temperature profile)(T° at 250° C. The screw speed is 300 rpm and the throughput is 100 kg/h.

The semicrystalline aliphatic polyamide and optionally the additives are added via the main hopper.

The compositions were then molded on an (Engel brand) injection molding machine at a setpoint temperature of 260° C. and a mold temperature of 70° C. in the form of dumbbells in order to study the properties of the compositions according to the standards below.

The tensile modulus was measured at 23° C. and 60° C. in accordance with the standard ISO 527-1:2012 on type 1A dumbbells.

The stress at break was also measured at 23° C. and 60° C. in accordance with this same standard ISO 527-1:2012. An Instron 5966 type machine is used. The crosshead speed was fixed at 1 mm/min for the measurement of the modulus and 5 mm/min for the measurement of the stress.

The creep strength was tested on type A test specimens at 60° C. under constant stress in accordance with the standard ISO899-1:2017.

The samples were tested either dry or after immersion in drinking water at 90° C.

The results are shown in table 2.

TABLE 1

| | E1 | E2 | E3 | E4 | E5 | E6 | E7 | CE1 | CE2 | CE3 |
|---|---|---|---|---|---|---|---|---|---|---|
| PA11- | 34 | | | | | | | | | |
| iv m-cresol = | | | | | | | | | | |
| 1.07 | | | | | | | | | | |
| PA11- | | 34 | 28 | 34 | | 49 | | | | |
| iv m-cresol = | | | | | | | | | | |
| 1.18 | | | | | | | | | | |
| PA11- | | | 6 | | | | | 34 | 49 | |
| iv m-cresol = | | | | | | | | | | |
| 1.41 | | | | | | | | | | |
| PA11- | | | | | | | 34 | | | |
| iv m-cresol = | | | | | | | | | | |
| 1.27 | | | | | | | | | | |
| PA11- | | | | | | | | | | 34 |
| iv m-cresol = | | | | | | | | | | |
| 1.33 | | | | | | | | | | |
| PA12- | | | | | 34 | | | | | |
| Iv m-cresol = | | | | | | | | | | |
| 1.22 | | | | | | | | | | |
| CSG-3PA820 | | | | 65 | | | | | | |
| glass fiber | | | | | | | | | | |
| FoodContact ™ | 65 | 65 | 65 | | 65 | 50 | 65 | 65 | 50 | 65 |
| 295-10 glass | | | | | | | | | | |
| fiber | | | | | | | | | | |
| Licowax ® E | 0.3 | 0.3 | 0.3 | 0.3 | 0.3 | 0.3 | 0.3 | 0.3 | 0.3 | 0.3 |
| Calcium | 0.3 | 0.3 | 0.3 | 0.3 | 0.3 | 0.3 | 0.3 | 0.3 | 0.3 | 0.3 |
| stearate | | | | | | | | | | |
| Irganox ® | 0.4 | 0.4 | 0.4 | 0.4 | 0.4 | 0.4 | 0.4 | 0.4 | 0.4 | 0.4 |
| 1010 | | | | | | | | | | |

E = composition according to the invention
CE = counterexample
The FoodContact ™ 295-10 glass fiber (of circular cross section with 10 μm diameter) is sold by the company Owens Corning.
The CSG3PA820 glass fiber (of non-circular cross section with 7 × 28 μm cross section) is sold by the company Nitto Boseki.
The PA11 and PA12 are produced by the applicant company.
The calcium stearate is sold by the company Greven.
Licowax ® E is sold by the company Clariant.
Irganox ® 1010 is sold by BASF.

TABLE 2

| | E1 | E2 | E3 | E4 | E5 | E6 | E7 | CE1 | CE2 | CE3 |
|---|---|---|---|---|---|---|---|---|---|---|
| Tensile modulus | 19.5 | 18.9 | 18.4 | 19 | 19.7 | 12.9 | — | 18.3 | 12.5 | — |
| (GPa) before | | | | | | | | | | |
| immersion-dry | | | | | | | | | | |
| state-23° C. | | | | | | | | | | |
| Breaking stress | 196 | 190 | 179 | 192 | 182 | 185 | — | 162 | 169 | — |
| (MPa)-before | | | | | | | | | | |
| immersion-dry | | | | | | | | | | |
| state-23° C. | | | | | | | | | | |
| Tensile modulus | 11.3 | 11.1 | 11 | 11.3 | 12.6 | 7.2 | 11.2 | 10.3 | 6.8 | 10.9 |
| (GPa)-before | | | | | | | | | | |
| immersion-dry | | | | | | | | | | |
| state-60° C. | | | | | | | | | | |
| Breaking stress | 145 | 143 | 135 | 146 | 140 | 139 | 137 | 116 | 125 | 119 |
| (MPa)-before | | | | | | | | | | |
| immersion-dry | | | | | | | | | | |
| state-60° C. | | | | | | | | | | |
| Breaking stress at | 115 | 111 | — | 113 | 110 | 103 | 115 | 93 | 92 | 93 |
| 60° C. (MPa)-after | | | | | | | | | | |
| 500 h of immersion | | | | | | | | | | |
| in drinking water at | | | | | | | | | | |
| 90° C. | | | | | | | | | | |
| Breaking stress at | 111 | 108 | — | 112 | 107 | 102 | 110 | 93 | 90 | 94 |
| 60° C. (MPa)-after | | | | | | | | | | |
| 1000 h of immersion | | | | | | | | | | |
| in drinking water at | | | | | | | | | | |
| 90° C. | | | | | | | | | | |
| Breaking stress at | 105 | 99 | — | 106 | 101 | 101 | 105 | 88 | 89 | 88 |
| 60° C. (MPa)-after | | | | | | | | | | |
| 2000 h of immersion | | | | | | | | | | |
| in drinking water at | | | | | | | | | | |
| 90° C. | | | | | | | | | | |
| Creep at 60° C., under | >100 h | >100 h | >100 h | >100 h | >100 h | — | >100 h | 26 h | — | 60 h |
| 100 MPa | | | | | | | | | | |
| Time to breakage | | | | | | | | | | |
| (Dry state) | | | | | | | | | | |
| Creep at 60° C., | >100 h | >100 h | >100 h | >100 h | >100 h | — | >100 h | 19 h | — | 35 h |
| immersed, under 70 | | | | | | | | | | |
| MPa | | | | | | | | | | |
| Time to breakage | | | | | | | | | | |
| (after 1000 h of | | | | | | | | | | |
| immersion in | | | | | | | | | | |
| drinking water) | | | | | | | | | | |
| Creep at 60° C., under | — | — | — | — | — | >100 h | — | — | 40 h | — |
| 90 MPa | | | | | | | | | | |
| Time to breakage | | | | | | | | | | |
| (Dry state) | | | | | | | | | | |

Composition E6 according to the invention has very markedly improved mechanical properties compared to CE2, determined at 23 and 60° ° C. in the dry state and after immersion in drinking water at 90° ° C. The creep strength at 60° ° C. is also markedly improved compared to a formulation composed of a polyamide matrix having an inherent viscosity >1.3.

1. A molding composition comprising, by weight:
a) 20% to 60% of at least one long-chain aliphatic polyamide having a number of carbon atoms per nitrogen atom of greater than or equal to 9, said at least one polyamide having an inherent viscosity in solution of less than or equal to 1.3, as determined in accordance with the standard ISO 307:2007 at a temperature of 20° C.,
b) 40% to 75% of glass fibers, said glass fibers being short glass fibers of circular cross section and having a fiber length of from 120 to 350 μm, and
c) 0% to 5% by weight, of at least one additive,
the sum of the proportions of each constituent of said composition being equal to 100%, with the exclusion of an amorphous polyamide and a microcrystalline polyamide.

2. The composition as claimed in claim 1, wherein at least two long-chain aliphatic polyamides are present in the composition.

3. The composition as claimed in claim 1, wherein the long-chain aliphatic polyamide is obtained by polycondensation:
of at least one C₉ to C₁₈ amino acid, or of at least one C₉ to C₁₈ lactam, or of at least one aliphatic diamine Ca of at least one C₄-C₃₆ diamine Ca with at least one C₄-C₃₆ dicarboxylic acid Cb, or a mixture thereof.

4. The composition as claimed in claim 1 wherein the long-chain aliphatic polyamide is obtained by polycondensation:
of at least one C₉ to C₁₈ amino acid, or of at least one C₉ to C₁₈ lactam.

5. The composition as claimed in claim 1, wherein said long-chain polyamide is chosen from PA1010, PA1012, PA1212, PA11 and PA 12, in particular PA11 and PA 12.

6. The composition as claimed in claim 1, wherein said long-chain polyamide is chosen from PA11 and PA 12.

7. The composition as claimed in claim 1, wherein said at least one additive is chosen from fillers, dyes, stabilizers, plasticizers, surface-active agents, nucleating agents, pigments, brighteners, antioxidants, lubricants, flame retardants, natural waxes, additives for laser marking, and mixtures thereof.

8. A method for the manufacture of an article for the field of sanitation, transport or distribution of water at a temperature of less than or equal to 60° C., the method comprising manufacturing the article from the composition as defined in claim 1.

9. The method as claimed in claim 8, wherein the article is chosen from a container, a conduit, a fitting, a connector, a quick connector, a screw, a flow-control device, an element of a flow-control device, a valve and a filter element and a structural part.

10. The method as claimed in claim 8, wherein the article has improved mechanical properties compared to an article the inherent viscosity in solution of which is greater than 1.3, determined at 23° C. in accordance with the standard ISO 527:2012 on a type 1A test specimen.

11. The method as claimed in claim 8, wherein the article has improved mechanical properties compared to an article the inherent viscosity in solution of which is greater than 1.3, determined at 60° C. in accordance with the standard ISO 527:2012 on a type 1A test specimen.

12. The method as claimed in claim 8, wherein the article has an improved creep strength compared to an article the inherent viscosity in solution of which is greater than 1.3, as determined in accordance with ISO 307:2007.

13. The method as claimed in claim 8, wherein the article is manufactured by injection molding.

14. An article obtained by injection molding with a composition as defined in claim 1.
